(19) United States
(12) Patent Application Publication
(10) Pub. No.: US 2006/0035510 A1
(43) Pub. Date: Feb. 16, 2006

(54) LSI package having interface function with exterior, circuit device including the same, and manufacturing method of circuit device

(76) Inventors: Hideo Numata, Yokohama-shi (JP); Chiaki Takubo, Tokyo (JP); Hideto Furuyama, Yokohama-shi (JP); Hiroshi Hamasaki, Hiratsuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/200,173

(22) Filed: Aug. 10, 2005

(30) Foreign Application Priority Data
Aug. 10, 2004 (JP) P2004-233751

(51) Int. Cl. H01R 13/62

(52) U.S. Cl. 439/372

(57) ABSTRACT

A LSI package having an interface function with an exterior and a circuit device including the same comprises an interposer having a conductive terminal for connection to a mounting board, and an interface module which is electrically and mechanically connected to a surface of the interposer on which the conductive terminal is disposed, and interfaces signal input/output from/to the exterior and the interposer. Alternatively, the interface module is electrically and mechanically connected to a surface opposite a surface of the mounting board to which the interposer is connected.

### CROSS-REFERENCE TO RELATED APPLICATIONS

This application is based upon and claims the benefit of priority from the prior Japanese Patent Application No. 2004-233751, filed on Aug. 10, 2004; the entire contents of which are incorporated herein by reference.

### BACKGROUND

1. Field of the Invention

The present invention relates to a LSI package having an interface function with an exterior, a circuit device including the same, and a manufacturing method of the circuit device.

2. Description of the Related Art

In recent years, the clock frequency inputted/outputted from/to a LSI is getting more and more higher, and a CPU for a personal computer that is operated with a frequency of GHz order has been put into practical use. However, the pace of the improvement in the performance (throughput) of a mediating function for signal input/output in a LSI package having the LSI therein (namely, an interface function in the LSI package) is moderate, compared with the increase in the clock frequency, which constitutes a bottleneck in improving the performance of the personal computer.

For improving the throughput of the interface, it is necessary to increase the signal frequency per terminal and to increase the number of terminals. However, there is a limit to the increase in the number of terminals because the increase in the number of terminals results in the enlargement of the areas of the LSI and the package to lengthen internal wiring, which hinders a high-frequency operation. Such being the case, the increase in the frequency per terminal is currently progressing. Here, the increase in the frequency per terminal results in larger attenuation of an electrical signal and a larger influence of the reflection due to impedance mismatch, which imposes a limit on the line length. Therefore, as a high-speed signal transmission line, it is necessary to use a transmission line with the smallest possible impedance mismatch and attenuation amount.

For realizing long-distance transmission with small influences by the impedance mismatch and by the loss, the use of an optical fiber is effective. In order to allow the use of the optical fiber, an optical interface module having an optical-electrical converting function is necessary. An example of such an optical interface module is described by J. Eichenberger et al. in “Multi-Channel Optical Interconnection Modules up to 2.5 GHz/s/ch”, 2001 Proceedings, 51st Electronic Components and Technology Conference, IEEE, pp. 880-885. The optical interface module described in this document is a so-called board edge type that performs the optical-electrical (or electrical-optical) conversion in an end portion of a mounting board.

When an optical interface module of the board edge type is used, owing to a very small loss and a small limit of the band in the optical fiber, an electrical signal once converted to an optical signal by the electrical-optical conversion can be transmitted at a high-speed of, for example, 10 Gbps, even if the transmission line is relatively long as in the transmission between mounting boards or between devices. However, the electrical signal has to be transmitted at a high speed in the mounting board, in which the longest transmission distance is about 300 mm, and in order to prevent the signal attenuation and the impedance mismatch, very expensive transmission lines are required. This causes cost increase of the mounting board.

A method being considered under the circumstances is to transmit a high-speed signal only within an interposer of an LSI package, thereby shortening electrical wiring that has to perform high-speed transmission, as described, for example, by Takashi Yoshikawa et al. in “Optical-Interconnection as an IP Macro of a CMOS Library”, HOT9 Interconnects, Symposium on High Performance Interconnects, IEEE, pp 31-35, and by Masahiro Kato et al. in “Encounter with Optical Interconnection”, Nikkei Electronics, Dec. 3, 2001, No. 810, pp. 121-122. In this case, an electrical signal is converted into an optical signal on the interposer and the optical signal is inputted/outputted from/to the exterior. In such a structure, the optical interface module is fixed on the interposer of the LSI package by soldering, and fibers having optical connectors are used for optical connection.

According to the configuration described above, the optical interface modules can be mounted on the interposer after they are individually packaged, which can improve reliability. Moreover, it is possible to mount only nondefective optical interface modules, so that it is possible, for example, to hold down inspection cost. Further, the optical connector can be connected after the interposer is mounted on the mounting board. This is advantageous in that no consideration to the restriction in handling the optical fiber is necessary when the interposer and other components are mounted, namely, there is no concern about a breakage that the optical fiber might suffer due to the deterioration or bending of shielding resin by heat treatment.

However, mutual interference among soldering of the LSI, soldering of the optical interface module, and, in some cases, soldering of the interposer may possibly occur. This poses a need for changing melting points of respective solders, restrictions on the mounting procedure, and so on, which is disadvantageous in that a freedom degree in mounting processes is narrowed. Further, in order to hold the optical connector in a proper position, a pushing mechanism is additionally required. Because of this reason and so on, the use of the connector for the optical connection tends to enlarge the mechanism. Therefore, for example, a recessed space has to be formed in a heat sink mounted on an upper portion of the LSI, which complicates the configuration. This causes cost increase. Furthermore, it may possibly become difficult to install a heat sink for heat release of the optical interface module.

In general, power consumption per terminal of a LSI tends to become larger in accordance with an increase in the frequency of a signal. For example, in recent years, the total power consumption of some LSI amounts up to 70 W to 80 W in a CPU used in a personal computer or the like. A configuration adopted under the circumstances is such that a heat spreader and a gigantic heat sink are mounted on a signal processing LSI so as to secure a large heat release area, and a forced air cooling is performed by using a fan or the like. On the other hand, the wiring length between the signal processing LSI and the interface module has to be as short as possible. Therefore, in the case where a heat sink for the signal processing LSI is installed, there is no allowance in the space for mounting another heat sink for the interface module.

Under the circumstances, a possible configuration is to share the heat sink by the signal processing LSI and the interface module so as to achieve simultaneously heat release therefrom. In this case, however, when the signal processing LSI and the interface module are mounted on the interposer at the same time, it is difficult to strictly align upper surfaces of the signal processing LSI and the interface module and to strictly control a difference in level therebetween at a prescribed value. Moreover, since the interface module is soldered, the expensive signal processing LSI has to be also renewed together in the event of the disorder of the interface module.

There also exists a configuration such that an optical element is mounted directly on the interposer and an optical waveguide made of an organic material is attached on the mounting board so as to form a transmission line, as described by Masahiro Okabe et al. in “Active Interposer Technology in Optical-Electrical Composite Packaging”, Collected Lecture Papers of the 16th JEEP Annual Meeting, Japan Institute of Electronics Packaging, Mar. 5, 2002, p. 283. In this configuration, the optical element as a bare chip is mounted directly on the interposer. When the interposer is mounted on a mounting board, the optical element is optically coupled to the optical waveguide. Therefore, it is difficult to maintain optical accuracy because of, for example, the difference in thermal expansion coefficient between the mounting board and the interposer.

Further, since it is difficult to ensure reliability of the bare optical element, some measure such as filling a surrounding area of the optical element with resin transparent to the wavelength of an optical signal is required. This means that a work on the mounting board is required, and many restrictions are imposed on the manufacturing processes, which results in higher manufacturing cost. Further, since an extra work of attaching the optical waveguide to the mounting board is necessary, the mounting process becomes complicated to increase mounting cost. This configuration also requires the renewal of the optical element together with the expensive signal processing LSI in the event of the disorder of the optical element.

### SUMMARY

A LSI package having an interface function with an exterior according to one embodiment of the present invention comprises: an interposer having a conductive terminal for connection to a board; and an interface module which is electrically and mechanically connected to a surface of the interposer on which the conductive terminal is disposed, and interfaces signal input/output from/to the exterior and the interposer.

A circuit device including a LSI package having an interface function with an exterior according to one embodiment of the present invention comprises: a mounting board; an interposer having a conductive terminal for connection to the mounting board and electrically and mechanically connected to the mounting board via the conductive terminal; and an interface module which is disposed between the mounting board and the interposer, is electrically and mechanically connected to a surface of the interposer on which the conductive terminal is disposed, and interfaces signal input/output from/to the exterior and the interposer.

A circuit device including a LSI package having an interface function with an exterior according to another embodiment of the present invention comprises: a mounting board having an opening portion; an interposer having a conductive terminal for connection to the mounting board and electrically and mechanically connected to the mounting board via the conductive terminal; and an interface module which passes through the opening portion of the mounting board to be electrically and mechanically connected to a surface of the interposer on which the conductive terminal is disposed, and interfaces signal input/output from/to the exterior and the interposer.

A circuit device including a LSI package having an interface function with an exterior according to still another embodiment of the present invention comprises: a mounting board; an interposer having a conductive terminal for connection to the mounting board and electrically and mechanically connected to the mounting board via the conductive terminal; and an interface module which is electrically and mechanically connected to a surface opposite a surface of the mounting board to which the interposer is connected, and interfaces signal input/output from/to the exterior and the interposer via the mounting board.

A manufacturing method of a circuit device including a LSI package having an interface function with an exterior according to an embodiment of the present invention includes: electrically and mechanically connecting to a mounting board an interposer having a conductive terminal for connection to the mounting board, with a surface on which the conductive terminal is disposed facing the mounting board; and electrically and mechanically connecting an interface module, which interfaces signal input/output from/to the exterior and the interposer, to the surface having the conductive terminal of the interposer connected to the mounting board.

### BRIEF DESCRIPTION OF THE DRAWINGS

The present invention will be described with reference to the drawings, but these drawings are presented only for an illustrative purpose, and in no way limit the invention.

FIG. 1A and FIG. 1B are cross-sectional views schematically showing a structure of a LSI package and a circuit device including the same, according to a first embodiment of the present invention.

FIG. 2 is a cross-sectional view schematically showing an example of a connection structure using a pin and a jack shown in FIG. 1A and FIG. 1B.

FIG. 3 is a cross-sectional view schematically showing a structure of a LSI package and a circuit device including the same, according to a second embodiment of the present invention.

FIG. 4 is a cross-sectional view schematically showing a structure of a circuit device including a LSI package, according to a third embodiment of the present invention.

FIG. 5 is a cross-sectional view schematically showing a structure of a LSI package and a circuit device including the same, according to a fourth embodiment of the present invention.

FIG. 6 is a cross-sectional view schematically showing a structure of a circuit device including a LSI package, according to a fifth embodiment of the present invention.

FIG. 7A and FIG. 7B are views showing a structure of an essential part of a LSI package according to a sixth embodiment of the present invention.

FIG. 8A and FIG. 8B are views showing a structure of an essential part of a circuit device including a LSI package, according to a seventh embodiment of the present invention.

### DETAILED DESCRIPTION

Hereinafter, embodiments of the present invention will be described. In a LSI package according to one embodiment of the present invention, an interface module is electrically and mechanically connected to a surface of an interposer on which a conductive terminal for connection to a board is disposed. Therefore, disposing the interface module gives no influence to a surface opposite the surface of the interposer on which the connection conductive terminal is disposed, and therefor, the opposite surface can be used for arranging an arbitrary structure. Consequently, the interface module contributes to a higher throughput, and in addition, it is possible to solve problems involved in mounting the interface module and to save mounting space.

In a circuit device according to one embodiment of the present invention, an interface module is electrically and mechanically connected to a surface of an interposer on which a conductive terminal for connection to a mounting board is disposed. The interface module is disposed between the mounting board and the interposer. An alternative structure is such that an interface module passes through an opening portion of a mounting board to be connected to an interposer. Therefore, disposing the interface module gives no influence to a surface opposite the surface of the interposer on which the connection conductive terminal is disposed, and therefore, the opposite surface can be used for arranging an arbitrary structure. Consequently, the interface module contributes to a higher throughput, and in addition, it is possible to solve problems involved in mounting the interface module and to save mounting space.

In a circuit device according to another embodiment of the present invention, an interface module is electrically and mechanically connected to a surface opposite a surface of a mounting board to which an interposer is connected via a connection conductive terminal. Therefore, disposing the interface module gives no influence to a surface opposite the surface of the interposer on which the connection conductive terminal is disposed, and therefore, the opposite surface can be used for arranging an arbitrary structure. Consequently, the interface module contributes to a higher throughput, and in addition, it is possible to solve problems involved in mounting the interface module and to save mounting space.

As a form of the LSI package of the present invention, the interposer can have an area to which a LSI is connected, the area being provided on a surface opposite the surface on which the connection conductive terminal is disposed. Further, the interposer can have a conductor passing through the interposer so as to connect the LSI connected to the area and the connection conductive terminal to each other, and shield members provided on a front and a rear surface of the interposer, respectively. In this structure, the shield members on the front and rear surfaces of the interposer alleviate the interference between signal lines.

Here, the interposer may have a capacitor buried therein, both ends of the capacitor being electrically connected to the shield members provided on the front and rear surfaces. An example of this structure is such that the shield members on the front and rear surfaces have continuity to the ground and a power source respectively, and a bypass capacitor constitutes the buried capacitor, thereby stabilizing the potential to improve a shielding effect.

As a form of the LSI package of the present invention, the interposer and the interface module may be connected to each other by a pin and a jack to/from which the pin is insertable/removable. As a form of the LSI package, the interposer and the interface module may be connected to each other via an anisotropic conductive film.

Further, as a form of the LSI package of the present invention, one of the interface module and the interposer can have a guide pin, and the other can have a guide hole to which the guide pin is inserted. As a form of the LSI package, the interface module can have a conductive terminal for continuity to the board, on a surface opposite the surface connected to the interposer. This structure is suitable, for example, for direct power supply to the interface module from the mounting board.

As a form of the LSI package of the present invention, the interface module can interface an electrical signal of the interposer and an optical signal of the exterior. An optical interface module thus performing optical-electrical conversion and electrical-optical conversion can be a typical example of the interface module. The optical interface module has, for example, an optical element mounted therein and an optical fiber optically coupled to the optical element.

As a form of the circuit device of the present invention, the interposer can have a LSI mounted on a surface opposite the surface on which the connection conductive terminal is disposed, a conductor passing through the interposer so as to connect the LSI and the connection conductive terminal to each other, and shield members provided on a front and a rear surface of the interposer. Here, the interposer can have a capacitor buried therein, both ends of the capacitor being electrically connected to the shield members provided on the front and rear surfaces.

Further, as a form of the circuit device, shield members can be disposed on a surface of the interposer facing the mounting board and a surface of the mounting board facing the interposer, and each of the shield members can have continuity to part of the connection conductive terminal. This is a structure for giving a shielding function to the part of the connection conductive terminal of the interposer.

As a form of the circuit device of the present invention, the interposer and the interface module can be electrically and mechanically connected to each other by a pin and a jack to which the pin is insertable. Alternatively, the mounting board and the interface module can be electrically and mechanically connected to each other by a pin and a jack to which the pin is insertable.

As a form of the circuit device of the present invention, the interposer and the interface module can be electrically and mechanically connected to each other via an anisotropic conductive film. Alternatively, the mounting board and the interface module can be electrically and mechanically connected to each other via an anisotropy conductive film.

As a form of the circuit device of the present invention, one of the interface module and the interposer may have a guide pin and the other may have a guide hole to which the guide pin is inserted. Alternatively, one of the interface module and the mounting board can have a guide pin and the other can have a guide hole to which the guide pin is inserted.

As a form of the circuit device of the present invention, the interface module can interface an electrical signal of the interposer and an optical signal of the exterior. An optical interface module thus performing optical-electrical conversion and electrical-optical conversion can be a typical example of the interface module. The optical interface module has, for example, an optical element mounted therein and an optical fiber optically coupled to the optical element.

Based on the foregoing, the embodiments of the present invention will be described with reference to the drawings. It should be noted that the drawings are presented only for an illustrative purpose and are not intended to limit the present invention, though the embodiments of the present invention will be described based on the drawings.

### First Embodiment

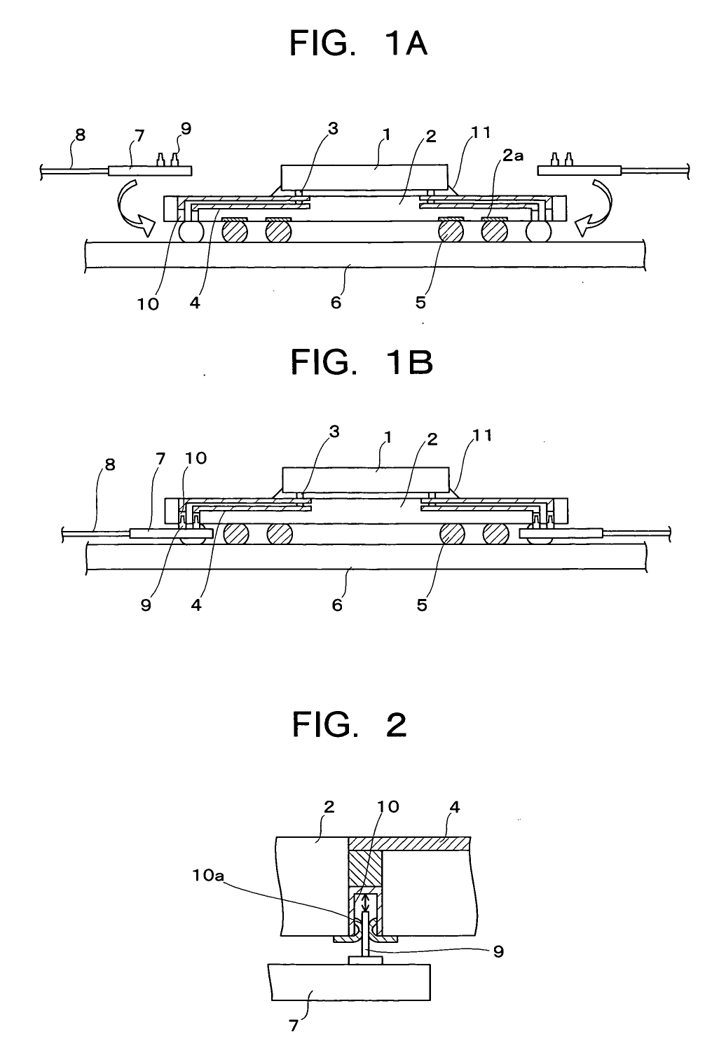

FIG. 1A and FIG. 1B are cross-sectional views schematically showing a structure of a LSI package and a circuit device including the same, according to a first embodiment of the present invention. FIG. 1A shows a state before optical interface modules are connected to an interposer, and FIG. 1B shows a state after the optical interface modules are connected to the interposer.

A signal processing LSI 1 is electrically and mechanically connected to an interposer 2 via metal bumps 3. Connecting portions by the metal bumps 3 are sealed with underfill resin 11. Electrical wirings 4 for high-speed signal are provided in the interposer 2. One-side ends of the electrical wirings 4 are connected to signal input/output terminals of the LSI 1 via the metal bumps 3. The other ends of the electrical wirings 4 have continuity to jacks 10 provided on a surface of the interposer 2 opposite a surface to which the LSI 1 is connected.

Each optical interface module 7 has therein an optical element, an optical element driving IC, and so on. Optical fibers 8 are connected to the optical interface module 7. The optical fibers 8 are optically coupled to the optical element mounted in the optical interface module 7. The optical interface module 7 further has pins 9 for connection to the interposer 2. The pins 9 are inserted to the jacks 10 of the interposer 2 for fixation.

FIG. 2 is a cross-sectional view schematically showing an example of a structure of the pin 9 and the jack 10. In FIG. 2, the same reference numerals are used to designate the same constituent elements as those shown in FIG. 1A and FIG. 1B. This structure example is characterized in that the jack 10 has a conductive spring 10a exhibiting a rebounding property in an inner direction of the radius of the jack 10. According to such a connection structure, when the pin 9 is inserted to the jack 10, the spring 10a and the pin 9 come into contact with each other owing to the rebounding force of the spring 10a and thus come to have continuity to each other. Therefore, it is possible to enhance reliability in electrical connection.

The optical interface module 7 and the interposer 2 also have connections of power sources, ground lines, low-speed control signal lines, and so on, though not shown. Connection conductive terminals 2a for connection to the mounting board 6 are disposed on the surface opposite the surface of the interposer 2 to which the LSI 1 is connected. The connection conductive terminals 2a are connected to the mounting board 6 via solder bumps 5. That is, the interposer 2 is electrically and mechanically connected to the mounting board 6 via the connection conductive terminals 2a and the solder bumps 5.

This structure makes it possible to mount the interposer 2 on the mounting board 6 through substantially the same process as that in mounting a LSI package with a typical BGA structure (the state in FIG. 1A) and thereafter electrically and mechanically connect the optical interface modules 7 to the interposer 2 by utilizing a gap between the interposer 2 and the mounting board 6(the state in FIG. 1B). That is, the interposer 2 together with other components can be mounted on the mounting board 6 by utilizing heat treatment such as reflow and laser heating and thereafter the optical interface modules 7 can be connected to the interposer 2. This achieves a structure highly suitable for packaging.

Since the optical interface modules 7 are packaged separately, reliability can be ensured. Further, the optical interface module 7 is a structure that can be inspected by itself. Therefore, the deterioration of yields of the mounting board 6 ascribable to a defective optical element can be prevented. Since the optical interface module 7 can be mounted on the interposer 2 without undergoing heat treatment, a little restriction is imposed in mounting it even when a pig tail method (a structure in which one-side ends of transmission lines are included in the interface module 7) is adopted. Moreover, a high-speed signal reaches the optical interface module 7 from the interposer 2 via the pin 9 without passing through a wiring of the mounting board 6, so that the electrical wiring can be shortened, which is advantageous for transmission of a high-frequency signal.

In this embodiment, the optical fibers 8 are not connected to the optical interface modules 7 via optical connectors, but are directly optically coupled to the optical elements mounted in the optical interface modules 7. Therefore, the optical interface module 7 can be downsized. Further, since the optical fibers 8 are connected in a lateral direction, the thickness of the optical interface module 7 can be reduced. Therefore, the gap between the interposer 2 and the mounting board 6 can be utilized for mounting the interface modules 7.

Moreover, according to this embodiment, it is possible to connect the optical interface module 7 to the interposer 2 even in a package such as a chip scale package in which the LSI 1 and the interposer 2 are substantially the same in size. This indicates that disposing the optical interface modules 7 gives no influence in terms of space to the surface (the surface to which the LSI 1 is connected) opposite the surface of the interposer 2 facing the mounting board 6. The chip scale package can be said to be an example utilizing such space for other purpose.

In this embodiment, the optical interface module 7 adopts the pig tail method and thus the optical interface module 7 including the optical coupling structure is housed in a separate package, thereby realizing downsizing, and the optical interface module 7 and the interposer 2 are mechanically and electrically connected to each other via the pins 9 and the jacks 10 provided therein. Such a package structure can provide the following effects.

Firstly, the length of electrical wiring between the signal processing LSI 1 and the optical interface module 7 can be shortened owing to the direct mounting of the optical interface module 7 on the interposer 2. Therefore, no expensive transmission line is needed for mounting the optical interface module 7 with a high throughput. Further, since external wiring of the optical interface module 7 is directly coupled thereto without using a connector, the structure of the optical interface module 7 does not become complicated. In addition, the interposer 2 and the optical interface module 7 can be coupled to each other by the electrical connection terminals (the pins 9 and the jacks 10), which eliminates the problem such as the interference between the soldering of the interposer 2 and the soldering of the optical interface module 7.

Further, since the optical coupling structure and the transmission line holding mechanism are housed in the separate package, it is possible to easily maintain optical accuracy and achieve electrical connection, which makes it possible to ensure reliability. It is possible to provide a LSI package with an interface module that matches well with the electrical packaging, without any need for a great change in the mounting board 6 or the interposer 2.

### Second Embodiment

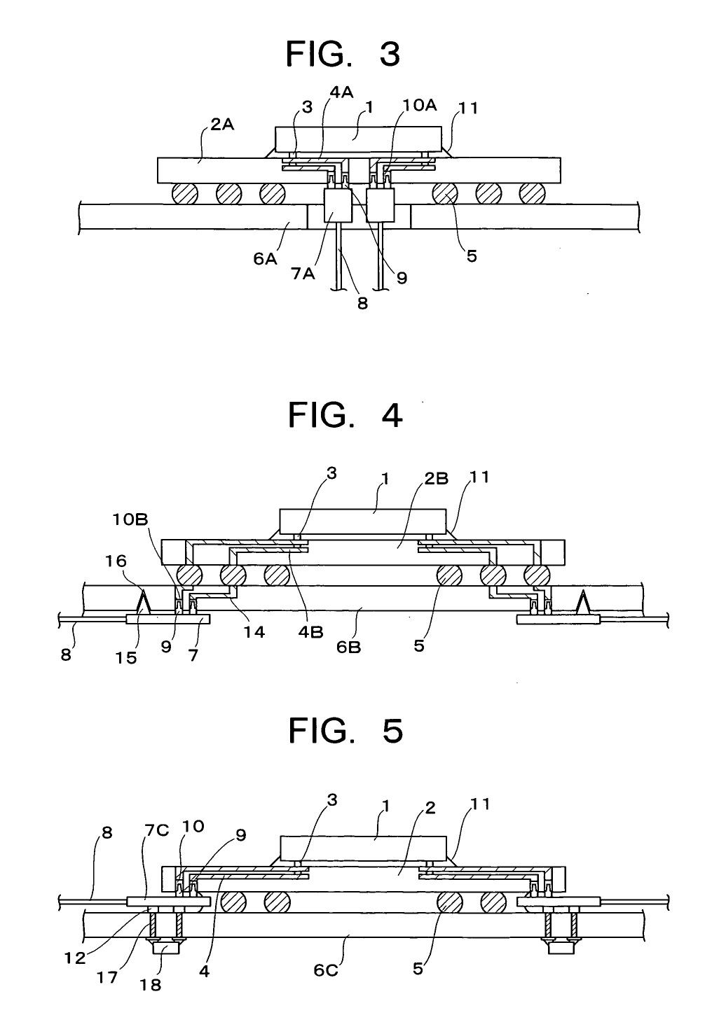

FIG. 3 is a cross-sectional view schematically showing a structure of a LSI package and a circuit device including the same, according to a second embodiment of the present invention. In FIG. 3, the same reference numerals are used to designate the same constituent elements as those previously described, and description thereof will be omitted unless additional description is needed.

The LSI package of this embodiment is the same as that of the first embodiment shown in FIG. 1 in that optical interface modules 7A are connected to a surface of the interposer 2A on which conductive terminals (not shown) for connection to a mounting board 6A are disposed. In this embodiment, however, opening portions are provided in the mounting board 6A, and optical fibers 8 are drawn out vertically to the interposer 2A. This connection structure makes it possible to connect the optical interface modules 7A in portions in which solder bumps 5 are not originally provided, in a center part of the interposer 2A. In the structure of thus providing the opening portions in the mounting board 6A, it is also possible to provide, at an end portion of the interposer 2A, jacks 10A having continuity to electrical wirings 4A, as in the embodiment shown in FIG. 1.

The LSI package of this embodiment has the following advantages. Specifically, the restrictions on the arrangement of the solder bumps 5 differ depending on the individual interposers 2A. In this respect, an area with no solder bump 5 in the interposer 2A can be utilized for arranging the optical interface modules 7A. This can enhance the degree of freedom in designing the LSI package. Further, even when a gap between the interposer 2A and the mounting board 6A is extremely narrow, for example, 0.2 mm, the optical interface modules 7A can be connected to the interposer 2A.

### Third Embodiment

FIG. 4 is a cross-sectional view schematically showing a structure of a circuit device including a LSI package according to a third embodiment of the present invention. In FIG. 4, the same reference numerals are used to designate the same constituent elements as those previously described, and description thereof will be omitted unless additional description is needed.

In the circuit device of this embodiment, optical interface modules 7 are connected to a rear surface (a surface opposite a side where an interposer 2B is provided) of a mounting board 6B, as shown in FIG. 4. High-speed electrical signals from/to a signal processing LSI 1 are transmitted to/from the optical interface module 7 via electrical wirings 4B of the interposer 2B, solder bumps 5, and electrical wirings 14 and jacks 10B of the mounting board 6B. This structure is somewhat disadvantageous in view of signal quality because of a longer electrical wiring route compared with those in the above-described embodiments, but greatly facilitates mounting the optical interface modules 7.

Incidentally, even though the electrical wiring route is made longer, the distance from the signal processing LSI 1 to the jacks 10B of the mounting board 6B is only about several % of the total distance of the entire transmission lines in most cases. Therefore, in this embodiment, it is also possible to constitute most part of a high-speed signal route by stable optical interconnection. Further, disposing the optical interface modules 7 does not give any influence in terms of space to the surface (surface to which the LSI 1 is connected) of the interposer 2B opposite the surface facing the mounting board 6B. Therefore, this space can be freely utilized for other purposes.

Incidentally, in order to respond to a case where the number of signal lines is increased and the pitch of pins 9 of the optical interface module 7 is narrowed for higher band of signals, a guide hole 16 is provided in the mounting board 6B and a guide pin 15 is provided in the optical interface module 7. The position of the guide hole 16 corresponds the position of the guide pin 15. According to this structure, only by positioning and inserting the guide pin 15 to the guide hole 16, it is possible to enhance positioning accuracy at the time of the connection. Consequently, it is possible to facilitate the positioning process in connecting the optical interface module 7 to the mounting board 6B. Such connection structure utilizing the guide pin 15 and the guide hole 16 is adoptable also in the embodiments described above.

After the optical interface modules 7 are connected to the mounting board 6B, an adhesive may be used to fix the optical interface modules 7 to the mounting board 6B. The adhesive is applied on, for example, the vicinity of both end portions of the optical interface modules 7 (perpendicular-direction both end portions relative to the drawing) so as to spread to the mounting board 6B. For example, a dispenser is used to drop down the adhesive in past form. Thereafter, the adhesive is cured by, for example, heating.

### Fourth Embodiment

FIG. 5 is a cross-sectional view schematically showing a structure of a LSI package and a circuit device including the same, according to a fourth embodiment of the present invention. In FIG. 5, the same reference numerals are used to designate the same constituent elements as those previously described, and description thereof will be omitted unless additional description is needed.

The fourth embodiment is different from the first embodiment shown in FIG. 1 in that power supply terminals 12 are provided as conductive terminals for continuity on a surface opposite a surface of each optical interface module 7C on which pins 9 are provided. The power supply terminals 12 are connected to power supply lines 17 provided in a mounting board 6C. A power source and the ground of the optical interface module 7C are directly connected to the power supply lines 17 of the mounting board 6C, so that power is supplied thereto. On a rear surface (a surface opposite the side where the interposer 2 is mounted) of the mounting board 6C, a noise filter chip or a capacitor 18 is provided as a bypass between the power supply lines 17. Incidentally, the connection of the optical interface module 7C to the mounting board 6C may rely on the use of pins and jacks similarly to the connection to the interposer 2.

According to the structure shown in FIG. 5, it is possible to easily avoid sharing the power source and the ground line of the optical interface module 7C with a signal processing LSI 1, so that the mutual interference of switching noises of the both is suppressed. In other words, it is not necessary to provide on the interposer 2 a structure for decoupling respective power supply lines of the signal processing LSI 1 and the optical interface modules 7C. Such decoupling requires an additional capacitor and the like to be mounted on the interposer 2. On the other hand, this embodiment can be also adopted when there is not a space large enough to mount such a component.

Specifically, a component such as a capacitor necessary in mounting and connecting the optical interface module 7C can be provided on the mounting board 6C side. Therefore, disposing the optical interface modules 7C does not give any influence in terms of space to the surface of the interposer 2 (the surface to which the LSI 1 is connected) opposite the surface facing the mounting board 6C, because there is no need for an additional component to be mounted on the interposer 2.

### Fifth Embodiment

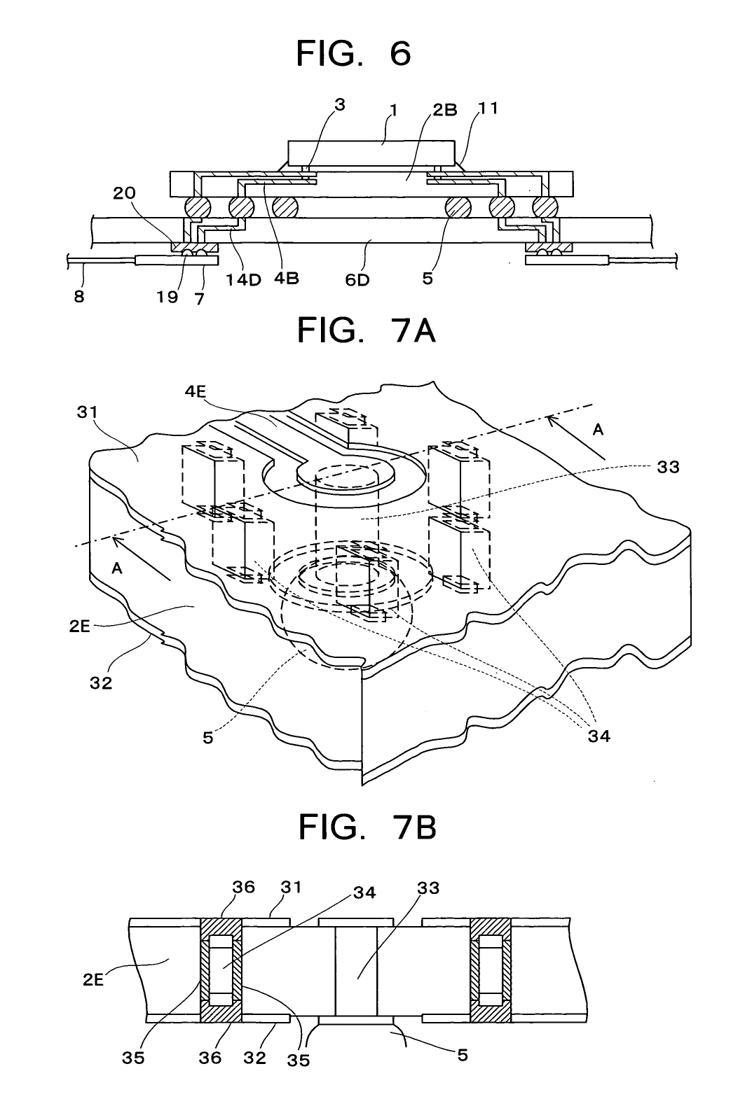

FIG. 6 is a cross-sectional view schematically showing a structure of a circuit device including a LSI package according to a fifth embodiment of the present invention. In FIG. 6, the same reference numerals are used to designate the same constituent elements as those previously described, and description thereof will be omitted unless additional description is needed.

The fifth embodiment is the same as the third embodiment shown in FIG. 4 in that optical interface modules 7 are connected to a surface opposite a surface of a mounting board 6D to which an interposer 2 is connected. However, pins/jacks are not used for connecting each of the optical interface modules 7 to the mounting board 6D but an anisotropic conductive film 20 is used. In order for the anisotropic conductive film to exhibit its anisotropic property, bumps 19 are provided on the optical interface module 7 here. The bumps 19 are pressed via the anisotropic conductive film 20 against electrodes which are provided on the mounting board 6D so as to have continuity to electrical wirings 14D, so that electrical continuity in a vertical direction can be obtained only in a portion where the pressing force is relatively large. The bumps may be provided also on the mounting board 6D side.

The use of the anisotropic conductive film 20 for connecting the optical interface module 7 to the mounting board 6D can also ensure a certain degree of mechanical connection owing to an adhesive property of the anisotropic conductive film 20. When the mechanical connection by the anisotropic conductive film 20 is not sufficient, an adhesive may be used to fix the optical interface module 7 to the mounting board 6D as described in the third embodiment shown in FIG. 4.

As the anisotropic conductive film 20, used is, for example, MT-T Type (brand name) manufactured by Shinetsu Polymer Co., Ltd. Such an anisotropic conductive film 20 can be reduced in thickness to, for example, about 100 μm. Therefore, a very thin connection structure can be achieved. Further, it is applicable to wider variety of mounting boards because it eliminates a need for providing jacks in the mounting board 6D.

### Sixth Embodiment

FIG. 7A and FIG. 7B are views showing a structure of an essential part of a LSI package according to a sixth embodiment of the present invention, FIG. 7A being a perspective view showing a structure of an interposer 2E and FIG. 7B being a cross-sectional view taken along the A-A line in FIG. 7A. In FIG. 7A and FIG. 7B, the same reference numerals are used to designate the same constituent elements as those previously described, and description thereof will be omitted unless additional description is needed. The interposer 2E of this embodiment is applicable to the LSI packages of the embodiments described above. That is, the structure of the interposer 2E is applicable to the interposers 2, 2A, 2B of the embodiments described above in a combined manner.

As shown in FIG. 7A and FIG. 7B, the interposer 2E of this embodiment is structured such that electrical wirings 4E have electrical continuity to an opposite surface through vias (vertical conductors) 33, and end portions thereof serve as connection portions to solder bumps 5 (see the embodiments described above). Further, power supply patterns 31 and ground patterns 32 are provided as shield members on upper and lower surfaces of the interposer 2E respectively, evading the vias 33 and the electrical wirings 4E. Further, a plurality of capacitors 34 whose both ends are electrically connected to the power supply patterns 31 and the ground patterns 32 are buried in the interposer 2E.

The capacitors 34 are buried, for example, in the following manner. First, through holes for burying the capacitors 34 therein are formed in the interposer 2E having the power supply patterns 31 and the ground patterns 32 on its both surfaces. Next, a small amount of a nonconductive resin adhesive 35 is put into the through holes, and the capacitors 34 are further inserted thereto in the vertical direction. Then, the adhesive 35 is cured while the capacitors 34 are kept at about middle positions of the through holes in terms of the vertical direction and electrodes at both ends thereof are kept uncovered by the adhesive 35.

When the adhesive 35 is cured, conductive resin 36 is filled in the through holes from the both surfaces of the interposer 2E and is further cured. Finally, the conductive resin 36 spreading out to the both surfaces of the interposer 2E is removed. In this manner, the capacitors 34 can be buried in the interposer 2E as shown in FIG. 7B. Commercially available products can be used as the capacitors 34. For example, commercially available capacitors with 0402 (0.4 mm length×0.2 mm width) size can be used, which is small enough to be buried in the interposer 2E.

According to the structure shown in FIG. 7A and FIG. 7B, it is possible not only to stabilize power supply voltage in the interposer 2E but also to alleviate the interference between high-speed signals transmitted through electrical wirings 4E. This effect is added to the effects in each of the embodiments described above.

### Seventh Embodiment

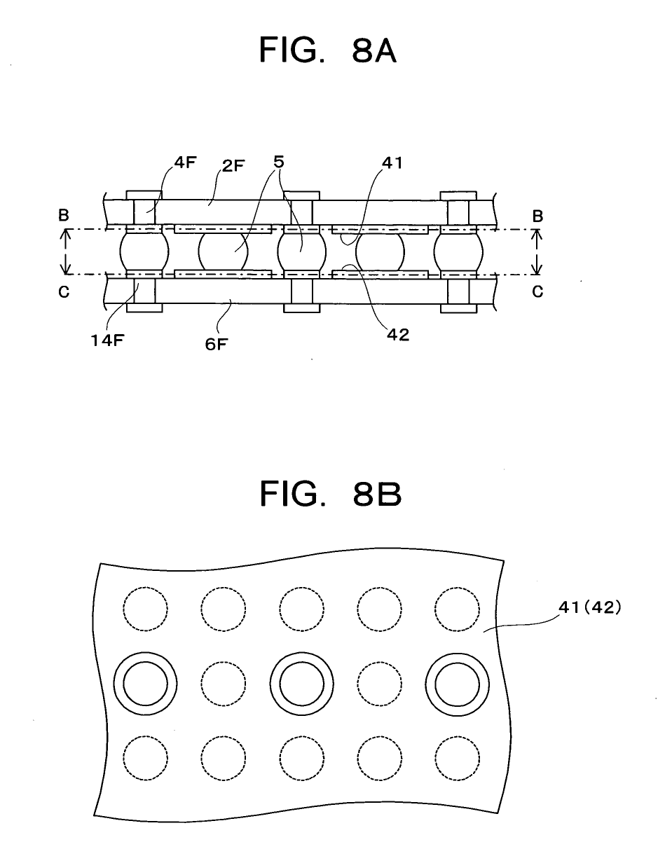

FIG. 8A and FIG. 8B are views showing a structure of an essential part of a circuit device including a LSI package according to a seventh embodiment of the present invention, FIG. 8A being a cross-sectional view and FIG. 8B being a partial cross-sectional view taken along the B-B line or the C-C line in FIG. 8A. The structure of this embodiment is preferably applied in a combined manner especially to the third embodiment shown in FIG. 4 and to the fifth embodiment shown in FIG. 6.

In this embodiment, ground patterns 41 and ground patterns 42 are provided as shield members on a surface of an interposer 2F facing a mounting board 6F and on a surface of the mounting board 6F facing the interposer 2F, respectively, and these ground patterns 41, 42 are electrically and mechanically connected to each other via dummy solder bumps 5. Electrical wirings 4F in a vertical direction provided in the interposer 2F and electrical wirings 14F in the vertical direction provided in the mounting board 6F are connected to solder bumps 5 other than the dummy solder bumps 5. High-speed signals are transmitted through these wirings. As shown in FIG. 8B, conducive portions through which the high-speed signals are transmitted are surrounded by the ground patterns 41, 42 and the dummy solder bumps 5.

According to the structure shown in FIG. 8A and FIG. 8B, the ground patters 41, 42 exhibit the shielding effect, so that the interference between the high-speed signals transmitted through the electrical wirings 4F, 14F can be alleviated. This effect can be added to the effects of the third embodiment shown in FIG. 4 and the fifth embodiment shown in FIG. 6.

It should be noted that the present invention is not limited to the above-described embodiments, but can be embodied in various modified forms without departing from the spirit of the present invention. In the above-described embodiments, the optical fiber is used as the transmission line, but as the transmission line, a coaxial cable or a semi-rigid cable may be used, or an electrical transmission line such as a flexible wiring board may be used. In any case, the same effects are obtainable. That is, instead of the optical interface module, a module in which a line driver IC for line driving and so on are mounted may be used. Further, the present invention can be embodied by appropriately combining the embodiments to an allowable extent, which can provide combined effects.

What is claimed is:

1. A LSI package having an interface function with an exterior, comprising:
an interposer having a conductive terminal for connection to a board; and
an interface module which is electrically and mechanically connected to a surface of the interposer on which the conductive terminal is disposed, and interfaces signal input/output from/to the exterior and the interposer.

2. The LSI package as set forth in claim 1, wherein the interposer has an area to which a LSI is connected, the area being provided on a surface opposite the surface on which the conductive terminal is disposed.

3. The LSI package as set forth in claim 2,
wherein the interposer has a conductor passing through the interposer so as to connect the LSI connected to the area and the conductive terminal to each other, and shield members provided on a front and a rear surfaces of the interposer, respectively.

4. The LSI package as set forth in claim 3,
wherein the interposer has a capacitor buried therein and electrically connected to the shield members provided on the front and rear surfaces.

5. The LSI package as set forth in claim 1, further comprising:
a pin and a jack to/from which the pin is insertable/removable as a mechanism connecting the interposer and the interface module to each other.

6. The LSI package as set forth in claim 1,
wherein the interface module interfaces an optical signal of the exterior and an electrical signal of the interposer.

7. A circuit device including a LSI package having an interface function with an exterior, comprising:
a mounting board;
an interposer having a conductive terminal for connection to the mounting board and electrically and mechanically connected to the mounting board via the conductive terminal; and
an interface module which is disposed between the mounting board and the interposer, is electrically and mechanically connected to a surface of the interposer on which the conductive terminal is disposed, and interfaces signal input/output from/to the exterior and the interposer.

8. The circuit device as set forth in claim 7,
wherein the interposer has a LSI mounted on a surface opposite the surface on which the conductive terminal is disposed, a conductor passing through the interposer so as to connect the LSI and the conductive terminal to each other, and shield members provided on a front and a rear surfaces of the interposer, respectively.

9. The circuit device as set forth in claim 7,
wherein the interface module has a conductive terminal disposed on a surface opposite a surface connected to the interposer and connected to the mounting board.

10. The circuit device as set forth in claim 7,
wherein the interface module interfaces an optical signal of the exterior and an electrical signal of the interposer.

11. A circuit device including a LSI package having an interface function with an exterior, comprising:
a mounting board having an opening portion;
an interposer having a conductive terminal for connection to the mounting board and electrically and mechanically connected to the mounting board via the conductive terminal; and
an interface module which passes through the opening portion of the mounting board to be electrically and mechanically connected to a surface of the interposer on which the conductive terminal is disposed, and interfaces signal input/output from/to the exterior and the interposer.

12. The circuit device as set forth in claim 11,
wherein the interposer has a LSI mounted on a surface opposite the surface on which the conductive terminal is disposed, a conductor passing through the interposer so as to connect the LSI and the conductive terminal to each other, and shield members provided on a front and a rear surfaces of the interposer, respectively.

13. The circuit device as set forth in claim 11,
wherein the interface module interfaces an optical signal of the exterior and an electrical signal of the interposer.

14. A circuit device including a LSI package having an interface function with an exterior, comprising:
a mounting board;
an interposer having a conductive terminal for connection to the mounting board and electrically and mechanically connected to the mounting board via the conductive terminal; and
an interface module which is electrically and mechanically connected to a surface opposite a surface of the mounting board to which the interposer is connected, and interfaces signal input/output from/to the exterior and the interposer via the mounting board.

15. The circuit device as set forth in claim 14,
wherein the interposer has a LSI mounted on a surface opposite the surface on which the conductive terminal is disposed, a conductor passing through the interposer so as to connect the LSI and the conductive terminal to each other, and shield members provided on a front and a rear surfaces of the interposer, respectively.

16. The circuit device as set forth in claim 14, further comprising:
a pin and a jack to/from which the pin is insertable/removable as a mechanism connecting the mounting board and the interface module to each other.

17. The circuit device as set forth in claim 14, further comprising:
an anisotropic conductive film as an electrical connection portion between the mounting board and the interface module.

18. The circuit device as set forth in claim 14,
wherein one of the interface module and the interposer has a guide pin, and the other has a guide hole to which the guide pin is inserted.

19. The circuit device as set forth in claim 14,
wherein the interface module interfaces an optical signal of the exterior and an electrical signal of the interposer.

20. A manufacturing method of a circuit device, comprising:
electrically and mechanically connecting to a mounting board an interposer having a conductive terminal for connection to the mounting board, with a surface on which the conductive terminal is disposed facing the mounting board; and
electrically and mechanically connecting an interface module, which interfaces signal input/output from/to the exterior and the interposer, to the surface having the conductive terminal of the interposer connected to the mounting board.
